(19) United States
(12) Patent Application Publication
(10) Pub. No.: US 2008/0126801 A1
(43) Pub. Date: May 29, 2008

(54) METHOD AND APPARATUS FOR GENERATING PROXY-SIGNATURE ON RIGHT OBJECT AND ISSUING PROXY SIGNATURE CERTIFICATE

(75) Inventors: Jae-won LEE, Yongin-si (KR); Bo-gyeong Kang, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd, Suwon-si (KR)

(21) Appl. No.: 11/753,130

(22) Filed: May 24, 2007

(30) Foreign Application Priority Data
Nov. 29, 2006 (KR) 2006-119136

(51) Int. Cl. H04L 9/00

(52) U.S. Cl. 713/167

(57) ABSTRACT

A method and apparatus for generating a proxy signature on a right object, and a method and apparatus for issuing a proxy signature certificate. The right object proxy signature method includes receiving a proxy signature certificate in which authority for right object conversion is specified, from a right issuer; receiving a right object from a first apparatus; signing the right object; and transmitting the signed right object and the proxy signature certificate to a second apparatus. Accordingly, by allowing a right object to be signed by a third right object proxy signature apparatus, not by a right issuer, users can freely share their own content between a variety of apparatuses, and the right issuer can reduce the load associated with the conversion and signature of right objects.

### CROSS-REFERENCE TO RELATED APPLICATION

This application claims the benefit of Korean Patent Application No. 2006-119136, filed in the Korean Intellectual Property Office on Nov. 29, 2006, the disclosure of which is incorporated herein by reference.

### BACKGROUND OF THE INVENTION

1. Field of the Invention

Aspects of the present invention relate to an apparatus and method for allowing apparatuses using Digital Rights Management (DRM) systems to share a right object and, more particularly, to an apparatus and method for allowing a right object proxy signature apparatus, instead of a right issuer that manages a right object of a second apparatus, to convert a right object of a first apparatus and to generate a proxy signature on the right object when the second apparatus tries to use content stored in the first apparatus, and a method and apparatus for allowing the proxy issuer to issue a proxy signature certificate.

2. Description of the Related Art

Digital Rights Management (DRM) systems manage content so that only authorized users can access and/or use the content. A right object is a file in which user authority is specified. Each of the content is assigned a right object. An apparatus that tries to use content must have the right object for the content. The right object is authenticated by a right issuer.

Using a DRM system refers to using an encryption method to protect content defined in the corresponding DRM system, a right object structure in which right items to reproduce the protected content are specified, and a key management method to encrypt and/or decrypt the content.

A DRM system requires an encryption technique for encrypting content. The DRM system stores the content and information about purchase of the content in a right object and keeps personal information in a certificate. The right object and the certificate are generated by a right issuer in the DRM system.

Generally, a DRM system includes a content provider providing content, a right issuer (for example, a license server) performing content management, such as providing a right object for content to users, changing or removing a right object for content, etc., and a content reproduction unit receiving the content from the content provider and reproducing the content with reference to the right object issued by the right issuer.

FIG. 1 is a view explaining a conventional right object conversion method performed between conventional DRM systems. Encrypted content is downloaded from a content provider 110 to a content storage unit 140 of a first apparatus 130. A user of the first apparatus 130 purchases a first right object from a right issuer 120 and stores the first right object in a right object storage unit 150, in order to reproduce the content through the first apparatus 130. The content stored in the content storage unit 140 and the first right object stored in the right object storage unit 150 are transmitted to a second apparatus 170 via an application 155.

The content is encrypted by a content encryption key included in the first right object. Accordingly, although an unauthorized apparatus may receive the content, the unauthorized apparatus cannot use the content because the unauthorized apparatus cannot recognize the first right object. The second apparatus 170 includes an application 195 to interpret the first right object, and has enough storage space to receive the content and the first right object from the first apparatus 130.

If the second apparatus 170 receives the content and the first right object through a physical connection with the first apparatus 130, the application 195 of the second apparatus 170 decrypts the content, stores the result of the decryption in a content storage unit 180, converts the first right object into a second right object based on the specification of a second DRM system, and stores the result of the conversion in a right object storage unit 190. Thereafter, the second apparatus 170 can reproduce the content stored in the content storage unit 180 using the second right object stored in the right object storage unit 190.

However, before the second apparatus 170 uses the second right object, the second right object must be authenticated by the right issuer 160. Accordingly, in the conventional right object conversion method, when an apparatus converts a right object into a new right object having a different format, the new right object must be authenticated by the right issuer 160.

When the first right object is converted by the second apparatus 170 or by a third apparatus, and not by the right issuer 160, the application 195, which converts and consumes the first right object, cannot determine whether the conversion of the first right object is authorized. The application 195 can determine whether conversion of the right object is authorized only through integrity authentication of the application 195. If a different type of DRM is added, the application 195 must be changed, which is inconvenient for users.

In conventional DRM systems, it is assumed that content must be reproduced only in an apparatus that has issued the corresponding right object. However, when several users' apparatuses are controlled by different DRM systems, if a user wants to reproduce purchased content in two or more of the apparatuses, the user must purchase separate right objects for the respective apparatuses in which the content will be reproduced. Furthermore, if the DRM systems controlling the apparatuses are not compatible, the content transmission between the apparatuses will be limited.

### SUMMARY OF THE INVENTION

Aspects of the present invention provide a method and apparatus to generate a proxy signature on a right object, which includes a proxy signature generator in a right object proxy signature apparatus, and to determine whether right object conversion is authorized through authentication of a converted right object, wherein the proxy signature generator generates a proxy signature that can be substituted for an original right issuer's signature.

Aspects of the present invention also provide a method and apparatus for issuing a proxy signature authentication, which allows a different apparatus, instead of a right issuer, to generate a proxy signature on a converted right object and to issue a proxy signature certificate.

Aspects of the present invention also provide a computer-readable recording medium having embodied thereon a program to execute the methods described above.

According to an aspect of the present invention, a method of generating a proxy signature on a right object is provided. The method includes receiving a proxy signature certificate, in which authority for right object proxy conversion is specified, from a right issuer; receiving a first right object from a first apparatus; signing the first right object; and transmitting the signed first right object and the proxy signature certificate to a second apparatus.

According to another aspect of the present invention, a method of issuing a proxy signature certificate is provided. The method includes receiving a proxy signature certificate request from a predetermined apparatus, wherein authority for right object proxy conversion is specified in the proxy signature certificate; generating the proxy signature certificate if the predetermined apparatus is authorized for right object conversion; and transmitting the proxy signature certificate to the predetermined apparatus.

According to another aspect of the present invention, an apparatus to generate a proxy signature on a right object is provided. The apparatus includes a receiver to receive a proxy signature certificate from a right issuer in which authority for right object proxy conversion is specified and to receive a first right object from a first apparatus; a proxy signature unit to sign the first right object; and a transmitter to transmit the signed first right object and the proxy signature certificate to a second apparatus.

According to another aspect of the present invention, an apparatus to issue a proxy signature certificate is provided. The apparatus includes a receiver to receive a proxy signature certificate request in which authority for right object proxy conversion is specified, from a predetermined apparatus; a proxy signature certificate generator to generate a proxy signature certificate if the predetermined apparatus is authorized for right object conversion; and a transmitter to transmit the proxy signature certificate to the predetermined apparatus.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view explaining a conventional right object conversion method which is performed between conventional Digital Rights Management (DRM) systems;

FIG. 2 is a block diagram of a DRM system according to an embodiment of the present invention;

FIG. 3 is a block diagram showing the construction of an apparatus for generating a proxy signature on a right object, according to an embodiment of the present invention;

FIG. 4 is a block diagram of a proxy signature certificate issuing apparatus according to an embodiment of the present invention;

FIG. 5 is a flowchart of a routine for generating a proxy signature on a right object, according to an embodiment of the present invention;

FIG. 6 is a flowchart of a proxy signature certificate issuing routine according to an embodiment of the present invention; and

FIG. 7 is a flowchart of a content reproducing routine which is performed by a content reproducing apparatus.

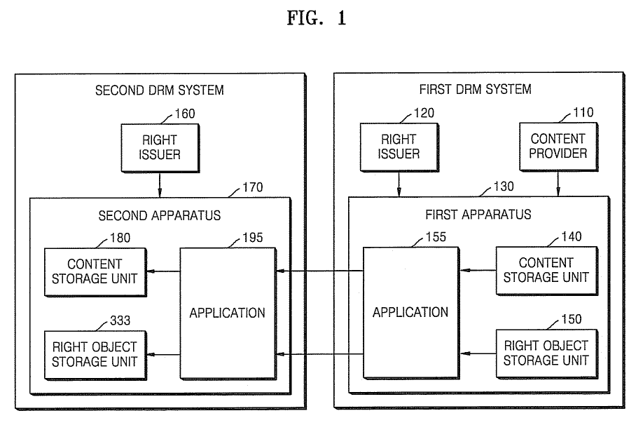

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

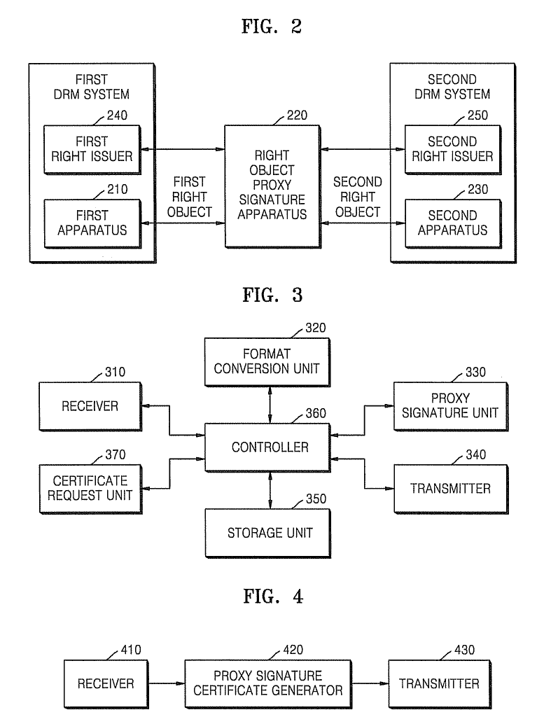

FIG. 2 is a block diagram of a Digital Rights Management (DRM) system according to an embodiment of the present invention. A first DRM system includes a first right issuer 240 and a first apparatus 210. A second DRM system includes a second right issuer 250 and a second apparatus 230. A right object proxy signature apparatus 220 may be located in the first DRM system, in the second DRM system, or in a different place. The first apparatus 210 and the second apparatus 250 may be a desktop computer, portable computer, mobile phone, personal digital assistant, personal entertainment device, set-top box, reproducing apparatus, or other device capable of storing and/or reproducing content.

The first right issuer 240 and the second right issuer 250, which belong to the first DRM system and the second DRM system, respectively, issue right objects, generate signatures on the right objects, and issue certificates. Each certificate is information indicating a client user's identity, and is similar to a certificate of seal-impression issued by actual administrative organs. The certificate contains user information and information about a content reproducing apparatus.

The first apparatus 210 receives a first right object issued by the right issuer 240. In order to send the first right object to the second apparatus 230, the first apparatus 210 first outputs the first right object to the right object proxy signature apparatus 220.

The right object proxy signature apparatus 220 receives the first right object from the first apparatus 210, converts the first right object into a second right object suitable to the specification of the second DRM system, signs the second right object in place of the second right issuer 250, and outputs the signed second right object to the second apparatus 230. The right object proxy signature apparatus 220, which can convert the first right object to the second right object, is authorized by the right issuers 240 and 250 for right object conversion and stores information about the authority in a storage unit 350 (shown in FIG. 3). In this way, users can directly and easily change right objects without using the right issuers 240 and 250.

The second apparatus 230 receives the second right object and the certificate from the right object proxy signature apparatus 220, extracts a content encryption key from the second right object, and then reproduces the content.

FIG. 3 is a block diagram of the right object proxy signature apparatus 220 illustrated in FIG. 2 according to an embodiment of the present invention. The right object proxy signature apparatus 220 will be described in detail with reference to FIGS. 2 and 3, below. A receiver 310 receives the first right object from the first apparatus 210. The receiver 310 receives the certificate (hereinafter referred to as a proxy signature certificate), which can generate the proxy signature on the first right object, from the first right issuer 240 and the second right issuer 250. The proxy signature certificate may be issued by a right issuer or by an authentication server authorized by the right issuer, and specifies an authorization item for processing right object conversion by proxy. A content reproducing apparatus can verify the proxy signature certificate using a previously stored right issuer's certificate.

A format conversion unit 320 converts the first right object into the second right object by changing a right item specified in the first right object according to a description format defined in the second DRM system.

A controller 360 compares the description format of the first right object with the description format of the second right object, outputs a control signal to send the first right object to a proxy signature unit 330 if the description format of the first right object is the same as the description format of the second right object, and outputs a control signal to send the first right object to the format conversion unit 320 if the description format of the first right object is different from the description format of the second right object.

A certificate request unit 370 requests the proxy signature certificate from the right issuers 240 and 250. When the proxy signature certificate is requested, the right issuers 240 and 250 receives a public key certificate application and a proxy public key of the right object proxy signature apparatus 220 from the right object proxy signature apparatus 220. The public key certificate application includes a digital signature encrypted by a proxy private key of the right object proxy signature apparatus 220.

The proxy private key and the proxy public key are keys based on a public key infrastructure. The proxy private key and the proxy public key are generated by the right object proxy signature apparatus 220, not by the right issuers 240 and 250.

When the format of the first right object is different from the format of the second right object, the proxy signature unit 330 receives the second right object from the format conversion unit 320 and signs the second right object in place of the second right issuer 250. If the format of the first object right is the same as the format of the second right object, the proxy signature unit 330 receives the first right object from the receiver 310, and signs the first right object in place of the second right issuer 250. The digital signature may be encrypted by a proxy signature key stored in the storage unit 350. The proxy signature key may be a proxy private key of a single apparatus that can generate a proxy signature on a right object.

The storage unit 350 stores the proxy signature key and the proxy signature certificate, which may be transmitted from the right issuers 240 and 250 and received through the receiver 310. If a proxy signature key request is received from the controller 360, the storage unit 350 outputs the proxy signature key to the proxy signature unit 330.

A transmitter 340 transmits the second right object (or the first right object) and the proxy signature certificate to the second apparatus 230. The second apparatus 230 receives the second right object (or the first right object) and reproduces the received content.

FIG. 4 is a block diagram of a proxy signature certificate issuing apparatus according to an embodiment of the present invention. The proxy signature certificate issuing apparatus will be described in detail with reference to FIGS. 2 and 4, below. The proxy signature certificate may be issued by the right issuer 240 or 250.

A receiver 410 receives a proxy key certificate application from the right object proxy signature apparatus 220. The receiver 410 may further receive a digital signature encrypted by the proxy public key, the public key certificate application, and the proxy private key, from the right object proxy signature apparatus 220.

A proxy signature certificate generator 420 receives the digital signature encrypted by the proxy public key, the public key certificate application, and the proxy private key, from the receiver 410, and generates a proxy signature certificate authorizing right object conversion. A transmitter 430 transmits the proxy signature certificate to the right object proxy signature apparatus 220.

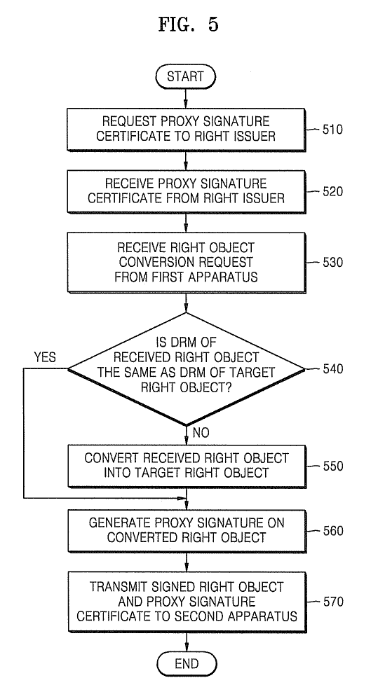

FIG. 5 is a flowchart of a right object proxy signature routine according to an embodiment of the present invention. The right object proxy signature method will be described in detail with reference to FIGS. 2, 3, and 5, below. First, the second right issuer 250 of the second DRM system and the right object proxy signature apparatus 220 confirm each other using an inter-authentication method. It is determined whether the right object proxy signature apparatus 220 has a qualification for right object conversion by the second DRM system.

In operation 510, the right object proxy signature apparatus 220 requests a proxy signature certificate from the second right issuer 250. When the right object proxy signature apparatus 220 requests the proxy signature certificate from the second right issuer 250, the right object proxy signature apparatus 220 transmits a proxy public key and a digital signature encrypted by a proxy private key to the second right issuer 250, in order to get authentication for the proxy public key and the proxy private key that are to be used to generate a proxy signature.

In operation 520, a proxy signature certificate is received from the second right issuer 250. Receiving the proxy signature certificate allows the right object proxy signature apparatus 220, instead of the second right issuer 250, to convert the format of a right object and generate a proxy digital signature on the converted right object in order to authenticate integrity and legality of the conversion. The proxy signature certificate may be stored in the storage unit 350. After operation 520, the right object proxy signature apparatus 220, instead of the right issuer 240 or 250, can perform right object conversion and generate a digital signature. The right object proxy signature apparatus 220 may generate a proxy private key for a digital signature to be attached to a converted right object and a proxy public key for signature verification, and may receive a public key certificate from a reliable right issuer in order to verify the validity of the proxy public key. An authorization item is specified in the proxy signature certificate. The proxy signature certificate is issued by the right issuer and can process right object conversion by proxy. The public key certificate may function as a proxy signature certificate.

In operation 530, the right object proxy signature apparatus 220 receives a first right object and a right object conversion request from the first apparatus 210. If the first apparatus 210 issues a right object conversion request, an identifier indicating a target DRM system that is to be converted, an identifier indicating a target apparatus that will use a converted right object, and the first right object that is to be converted, are transmitted to the right object proxy signature apparatus 220. The target apparatus may be a single apparatus or a plurality of apparatuses. A determination of whether the target apparatus is a single apparatus or a plurality of apparatuses depends on an apparatus identifier or a domain identifier. Secret information, such as a content encryption key, etc., in the first right object may be encrypted by the proxy public key of the right object proxy signature apparatus 220, in order to prevent the secret information from becoming public.

In operation 540, the controller 360 determines whether the DRM of the first right object received through the receiver 310 is the same as the DRM of a second right object to which the first right object will be converted. If the DRM of the first right object is the same as the DRM of the second right object, the controller 360 generates a control signal to output the first right object to the proxy signature unit 330. If the DRM of the first right object is different from the DRM of the second right object, the controller 360 generates a control signal to output the first right object to the format conversion unit 320.

In operation 550, if the DRM of the first right object is different from the DRM of the second right object, the format conversion unit 320 converts the first right object into the second right object by changing right items defined in the first right object to a format defined in a second DRM system, with reference to the target DRM system identifier included in the right object conversion request of the first apparatus 210.

In operation 560, in order to verify integrity and legality of the second right object converted in operation 550, the proxy signature unit 330 generates a proxy signature on the second right object. In order to verify content integrity of a right object in which a user's right items for content are specified and to determine whether the right object is generated by an authorized right issuer, a conventional DRM system attaches a digital signature of a right issuer to the right object. Aspects of the present invention allow a proxy signature unit, instead of a right issuer, to generate a digital signature on a right object.

In operation 570, the proxy signature certificate and the signed second right object are transmitted to the second apparatus 230 through the transmitter 340. When the proxy signature certificate and the second right object are transmitted to the second apparatus 230, the second right object may be encrypted by the proxy public key of the right object signature apparatus 220. The identifier indicating the second DRM system of the second right object and the identifier indicating the target apparatus to which the second right object will be transmitted may be included in the right object conversion request of the first apparatus 210. The target apparatus may be a single apparatus or a plurality of apparatuses. A determination of whether the target apparatus is a single apparatus or a plurality of apparatuses depends on an apparatus identifier or a domain identifier.

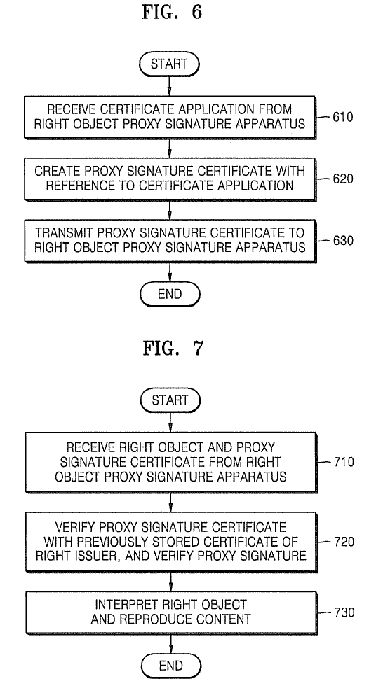

FIG. 6 is a flowchart of a proxy signature certificate issuing routine according to an embodiment of the present invention. The proxy signature certificate issuing method will be described in detail with reference to FIGS. 2 and 6, below.

In operation 610, a proxy signature certificate application is received from the right object proxy signature apparatus 220. In order to get authentication for a pair of proxy keys to be used to generate a proxy signature, a digital signature encrypted by a proxy public key, a public key certificate application, and a proxy private key may be received from the right object proxy signature apparatus 220. In operation 620, if the digital signature encrypted by the proxy public key, the public key certificate application, and the proxy private key is received, a proxy signature certificate in which authority for right object conversion is specified is generated. In operation 630, the proxy signature certificate is transmitted to the right object proxy signature apparatus 220.

FIG. 7 is a flowchart of a content reproducing method performed by a content reproducing apparatus. In operation 710, a right object and a proxy signature certificate are received from the right object proxy signature apparatus 220. The right object may be a right object transmitted by the first apparatus 210, or a converted result of a right object transmitted by the first apparatus 210. The right object may also be a proxy-signed right object regardless of conversion.

In operation 720, the received proxy signature certificate is verified on the basis of a certificate of the second right issuer 250 stored in the second apparatus 230. A proxy signature included in the right object is verified according to the verified proxy signature certificate. Through the proxy signature verification, it is possible to verify the legality of right object conversion. In operation 730, the right object received in operation 710 is interpreted and the content is reproduced.

In a right object proxy signature method and apparatus according to aspects of the present invention, when a right object with the format of a first DRM system is converted into a right object with the format of a second DRM system, a digital signature to verify the integrity and legality for the converted right object is generated by a right object proxy signature apparatus which users can easily access, instead of by a right issuer.

In the right object proxy signature method and apparatus according to aspects of the present invention, authority for issuing a proxy signature certificate, signing a right object, and converting a right object is assigned to a right object proxy signature apparatus.

In the right object proxy signature method and apparatus according to aspects of the present invention, a process for converting and proxy-signing a right object issued by a first DRM system so that an apparatus adopting a second DRM system can consume the right object, is performed in the same way as a process to convert and proxy-sign a right object issued by the second DRM system.

Digital rights management systems according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CDs and DVDs; magneto-optical media such as optical disks; and hardware devices that are specially configured to store and perform program instructions, such as read-only memory (ROM), random access memory (RAM), flash memory, and the like; and a computer data signal embodied in a carrier wave comprising a compression source code segment and an encryption source code segment (such as data transmission through the Internet). The computer readable recording medium can also be distributed over network coupled computer systems so that the computer readable code is stored and executed in a distributed fashion. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to aspects of the present invention, since a user apparatus, instead of an original right issuer, can generate a digital signature and issue a right object, when right objects are converted between DRM systems and particularly new right objects are issued by converting the format of existing right objects, users can freely share content between apparatuses adopting different DRM systems. The original right issuer can minimize a load associated with the conversion of the right objects. According to additional aspects of the present invention, since a proxy signature generator that can attach a signature of an original right issuer by a proxy is included in a right object proxy signature apparatus, it can be determined whether right object conversion is authorized through authentication for a converted right object. Furthermore, according to aspects of the present invention, when a DRAM system to which right object conversion will be applied is newly added, function updating can be easily performed by getting a certificate.

If a user possesses a plurality of apparatuses adopting different DRM systems, a right object that is previously issued can be easily converted into a format suitable to the different DRM systems, so that content can be shared between the plurality of apparatuses adopting the different DRM systems. By allowing a right object proxy signature apparatus, instead of a server, to perform such right object conversion, users can freely share their own DRM content between a variety of apparatuses, and the server can minimize a load associated with right object conversion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of generating a proxy signature on a right object, comprising:
receiving a proxy signature certificate, in which authority for right object proxy conversion is specified, from a right issuer;
receiving a first right object from a first apparatus;
signing the first right object; and
transmitting the signed first right object and the proxy signature certificate to a second apparatus.

2. The method of claim 1, wherein:
the receiving of the right object comprises converting the first right object into a second right object through format conversion if the format of the first right object is different from the format of a second right object of the second apparatus; and
the signing of the first right object comprises signing the second right object.

3. The method of claim 1, wherein:
the receiving of the proxy signature certificate comprises transmitting a digital signature encrypted by a proxy private key and a proxy public key based on a public key infrastructure to the right issuer; and
the signing of the first right object comprises encrypting the digital signature by the proxy private key.

4. The method of claim 1, wherein the right issuer issues the first right object and determines whether the first right object is authorized.

5. The method of claim 1, wherein the receiving of the first right object comprises receiving, from the first apparatus, an identifier indicating a DRM system of the second apparatus and an identifier indicating the second apparatus.

6. The method of claim 1, wherein the second apparatus is a single apparatus or a plurality of apparatuses.

7. A method of issuing a proxy signature certificate, the method comprising:
receiving a proxy signature certificate request from a predetermined apparatus, wherein authority for right object proxy conversion is specified in the proxy signature certificate;
generating the proxy signature certificate if the predetermined apparatus is authorized for right object conversion; and
transmitting the proxy signature certificate to the predetermined apparatus.

8. The method of claim 7, wherein the receiving of the proxy signature certificate request comprises receiving a digital signature encrypted by a proxy private key and a proxy public key based on a public key infrastructure.

9. An apparatus to generate a proxy signature on a right object, comprising:
a receiver to receive a proxy signature certificate from a right issuer in which authority for right object proxy conversion is specified, and to receive a first right object from a first apparatus;
a proxy signature unit to sign the first right object; and
a transmitter to transmit the signed first right object and the proxy signature certificate to a second apparatus.

10. The apparatus of claim 9, further comprising a format conversion unit to convert the first right object into a second right object of the second apparatus through format conversion if the format of the first right object is different from the format of the second right object of the second apparatus and to output the second right object to the proxy signature unit.

11. The apparatus of claim 9, further comprising:
a certificate request unit to transmit a digital signature encrypted by a proxy private key and a proxy public key based on a public key infrastructure to the right issuer;
wherein the proxy signature unit encrypts the digital signature using the proxy private key when the proxy signature unit signs the first right object using the digital signature.

12. The apparatus of claim 9, wherein the right issuer issues the first right object and determines whether the right object is authorized.

13. The apparatus of claim 9, wherein the receiver receives, from the first apparatus, an identifier indicating a DRM system of the second apparatus and an identifier indicating the second apparatus.

14. The apparatus of claim 9, wherein the second apparatus is a single apparatus or a plurality of apparatuses.

15. An apparatus to issue a proxy signature certificate, comprising:
a receiver to receive a proxy signature certificate request in which authority for right object proxy conversion is specified, from a predetermined apparatus;
a proxy signature certificate generator to generate a proxy signature certificate if the predetermined apparatus is authorized for right object conversion; and
a transmitter to transmit the proxy signature certificate to the predetermined apparatus.

16. The apparatus of claim 15, wherein, when the receiver receives the proxy signature certificate request, the receiver receives a proxy public key based on a public key infrastructure and a digital signature encrypted by a proxy private key of the predetermined apparatus.

17. A computer-readable recording medium having embodied thereon a program to execute the method of claim 1.

18. A computer readable medium having instructions that, when executed by a computer, cause the computer to perform the method of claim 7.

19. The method of claim 1, further comprising:
receiving a request for the proxy signature certificate; and
generating the proxy certificate if conversion of the first right object conversion is authorized.
